(19) United States
(12) Patent Application Publication
(10) Pub. No.: US 2008/0219090 A1
(43) Pub. Date: Sep. 11, 2008

(54) Systems for mixing a frozen dessert

(76) Inventors: Duane H. Heinhold, Salt Lake City, UT (US); Kenneth E. Heinhold, Salt Lake City, UT (US); Don H. Savage, St. George, UT (US)

Correspondence Address: THORPE NORTH & WESTERN, LLP., P.O. Box 1219, SANDY, UT, 84091-1219, US

(21) Appl. No.: 12/074,874

(22) Filed: Mar. 5, 2008

Related U.S. Application Data
(60) Provisional application No. 60/905,228, filed on Mar. 5, 2007.

(51) Int. Cl. B01F 7/00; B01F 13/04

(52) U.S. Cl. 366/261

(57) ABSTRACT

A dessert mixing machine comprises a housing and a motor driven drive shaft associated with the housing. An auger is operably attached to the drive shaft, the auger being rotated when the motor driven shaft is rotated. A mixing cone is provided, with the mixing cone and the auger being moveable relative to one another. A drive assembly for moving the mixing cone and the auger relative to one another is also provided. A locking system is operable to restrict or limit movement of the mixing cone and the auger relative to one while the auger is being rotated by the motor driven shaft.

Priority is claimed of copending U.S. Provisional Patent Application No. 60/905,228, filed Mar. 5, 2007, which is hereby incorporated herein in its entirety.

### FIELD OF THE INVENTION

The present invention relates generally to machines for mixing food products. More particularly, the present invention relates to machines for mixing and dispensing frozen desserts.

### BACKGROUND OF THE INVENTION

A variety of machines for mixing frozen desserts have been developed to date. U.S. Pat. Nos. 4,974,965 and 5,067,819, and pending U.S. patent application Ser. No. 11/116,914, to at least some of the present inventors, disclose examples of such machines. The entire contents of these references are incorporated herein by reference.

While such machines have been developed, presently some challenges remain to be addressed. For example, operators of such machines have been known to have difficulty in simultaneously operating the machines while dispensing product from the machines.

### SUMMARY OF THE INVENTION

In accordance with one aspect of the invention, a dessert mixing machine is provided, including: a housing, and a motor driven drive shaft associated with the housing. An auger can be operably attached to the drive shaft, the auger being rotated when the motor driven shaft is rotated. A mixing cone can also be provided, with the mixing cone and the auger being moveable relative to one another. A drive assembly can move the mixing cone and the auger relative to one another. A locking system can be operable to restrict or limit movement of the mixing cone and the auger relative to one while the auger is being rotated by the motor driven shaft.

In accordance with another aspect of the invention, a dessert mixing machine is provided, including: a housing, and a motor driven drive shaft associated with the housing. An auger can be attached to a distal end of the drive shaft, the auger being rotatable when the motor driven shaft is rotated. A mixing cone can also be provided, the mixing cone and the auger being moveable relative to one another. A drive assembly can cause movement of the mixing cone and the auger relative to one another. The drive assembly can include a hand lever graspable by a user of the machine to move the mixing cone and the auger relative to one another. A locking system can be operable to restrict or limit movement of the mixing cone and the auger relative to one while the auger is being rotated by the motor driven shaft. A locking system actuating switch can be selectively operable to engage and disengage the locking system. The locking system actuating switch can be coupled to the hand lever to enable a user to access the actuating switch while grasping the hand lever.

In accordance with another aspect of the invention, a method of mixing and dispensing a dessert is provided, including: introducing ingredients into a mixing cone; positioning a motor driven auger within the mixing cone and mixing the ingredients with the auger; restricting movement of the mixing cone and the auger relative to one another; and dispensing dessert from the mixing cone while movement of the mixing cone and the auger relative to one another is restricted.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 is a side, partially sectioned view of a dessert mixing machine in accordance with an embodiment of the invention, shown with one or more panels removed from the view to aid in illustrating various operating components of the machine;

FIG. 2 is a front, partially sectioned view of the dessert mixing machine of FIG. 1, shown with one or more panels removed from the view to aid in illustrating various operating components of the machine;

FIG. 3 is an opposing side view of the dessert mixing machine of FIG. 1, shown with one or more panels removed from the view to aid in illustrating various operating components of the machine; and

FIG. 4 is a partially sectioned, more detailed view of various components of a locking system in accordance with an embodiment of the invention.

It will be understood that the attached figures are merely for illustrative purposes in furthering an understanding of the invention. The figures may not be drawn or shown to scale, thus dimensions, particle sizes, and other aspects can be exaggerated to make illustrations thereof clearer. Therefore, departure can be made from the specific dimensions and aspects shown in the figures in order to produce the systems of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to an “auger” can include one or more of such augers.

### DEFINITIONS

In describing and claiming the present invention, the following terminology will be used in accordance with the definitions set forth below.

As used herein, relative terms, such as “upper,” “lower,” “upwardly,” “downwardly,” etc., are used to refer to various components of dessert mixing machines of the present invention, as those terms would be readily understood by one of ordinary skill in the relevant art. It is to be understood that the use of such terms in no way limits the present invention but is only to aid in describing the components of the mixing machines in the most straightforward manner.

As used herein, the term “substantially” refers to the complete or nearly complete extent or degree of an action, characteristic, property, state, structure, item, or result. As an arbitrary example, when an object or group of objects is/are referred to as being “substantially” symmetrical, it is to be understood that the object or objects are either completely symmetrical or are nearly completely symmetrical. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As an arbitrary example, an opening that is “substantially free of” material would either completely lack material, or so nearly completely lack material that the effect would be the same as if it completely lacked material. In other words, an opening that is “substantially free of” material may still actually contain some such material as long as there is no measurable effect as a result thereof.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

### INVENTION

As shown by example in the figures, in one embodiment the present invention provides a dessert mixing machine 10 for use in preparing frozen comestibles such as smoothies, shakes, malts, soft ice cream combinations, and the like. The system 10 can generally include a mixing auger 12, a motor 14, a pulley system 16 and a drive shaft 18 for driving the auger 12. A mixing cone 20 is provided that can be oriented in coaxial alignment with the mixing auger 12. A housing 22 can be provided to generally cover shield the various operating components of the system. (Note that the housing 22 is shown in varying degrees of completion in the figures: in order to most clearly illustrate the various working components of the system, some of the panels of the housing are omitted from some of the views).

Various components of the system 10, including the auger 12, the motor 14, pulley system 16, drive shaft 18, housing 22 and mixing cone 20 can be comprised of conventional components. The patents and the patent application referred to above give a full and complete description of the general makeup and operation of such mixing apparatus.

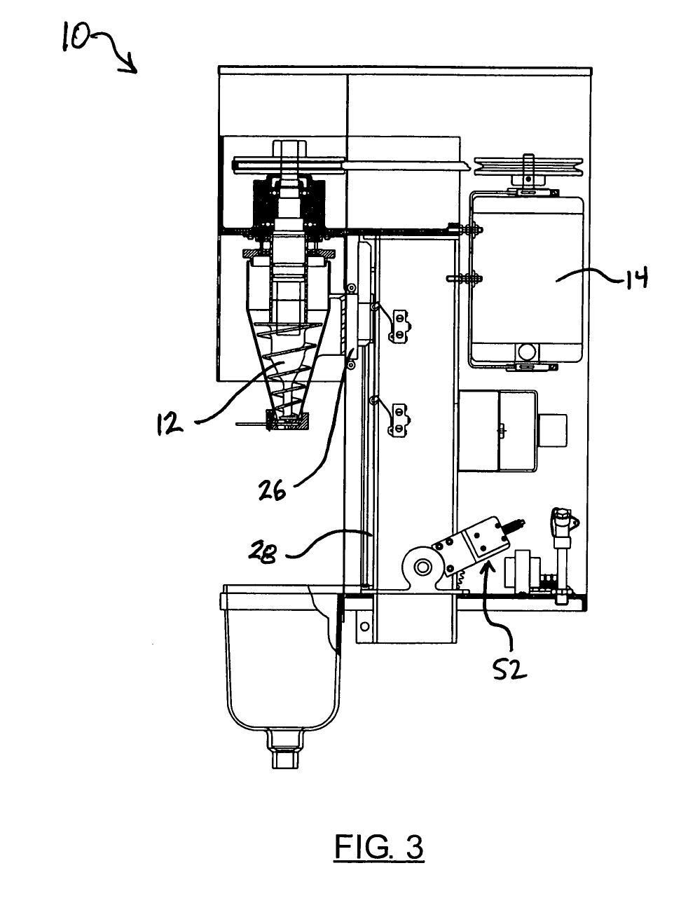

The system can include a mixing cone 20 attached to a carriage 26 (best seen in FIG. 3) that can be configured to travel upwardly and downwardly along a vertical support post. The carriage 26 can be slidably mounted on a rigid, elongate track 28 (FIG. 3) for linear, reciprocating movement toward and away from the auger 12 (alternately, the auger can be mounted on a slidable interface for movement toward and away from the mixing cone). The carriage 26 is designed to move along the track 28 with a minimum of frictional resistance. To this end, it is advantageous to provide a track 28 having parallel, spaced side edges which form a race for ball bearings mounted within the carriage 26.

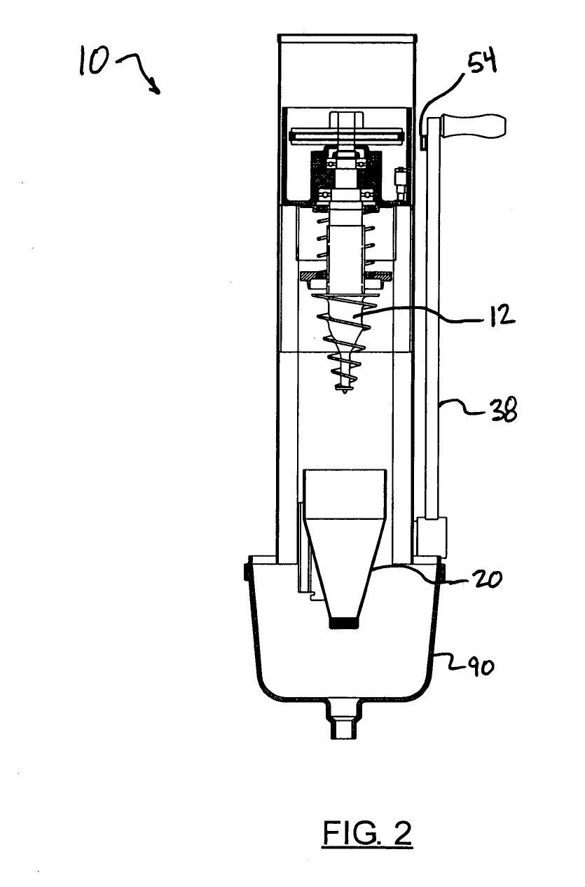

A gear mechanism or assembly 40 can be provided within the housing 22. A drive shaft 36 of the gear mechanism 40 can extend from the gear mechanism 40 through a side wall of the housing 22. A lever 38 (FIG. 2) can extend from the drive shaft 36 to be positioned adjacent to (but spaced slightly from the side of) the housing 22 such that the lever can be moved in a pivotal movement about the drive shaft 36. The gear mechanism 40 can have an output drive sprocket 42 which is driven in rotational motion upon pivotal movement of the lever 38.

An upper idler sprocket 32 can be positioned above the auger 12 and generally in line with the longitudinal length of the track 28. A drive chain 34 can be connected at one end to the carriage 26. The drive chain 34 can extend from the carriage 26 around the upper idler sprocket 32 to the drive sprocket 42 of the gear mechanism 40. The drive chain 34 can extend around the drive sprocket 42 to and around a lower idler sprocket 37 and back to the carriage 26. When the lever 38 of the gear mechanism 40 is moved upwardly and downwardly in pivotal movement, the drive chain 34 moves around the drive sprocket 42 so as to move the carriage 26 and the mixing cone 20 mounted thereon in linear movement toward and away, respectively, from the auger 12.

In one aspect of the invention, a sealing mechanism can be provided to seal the top of the mixing cone 20 when the mixing cone 20 has been moved toward the auger 12 so that the auger 12 is positioned within the mixing cone 20. In this manner, liquids such as milk can be introduced into the mixing cone 20 to be mixed with a frozen material such as ice cream to make a conventional, semi-liquid milk shake. The top of the mixing cone 20 can be sealed to prevent liquid and semi-liquid material from being ejected or forced from the top of the mixing cone 20 by the vigorous mixing action of the auger 12.

The sealing of the top of the mixing cone 20 can also allow a cleaning and sanitizing solution to be introduced into the mixing cone 20 when desired. When the auger 12 is activated with the cleaning and sanitizing solution in the mixing cone, a vigorous, thorough cleaning and sanitizing of the auger 12 and mixing cone 20 can be achieved. The sealing mechanism for sealing the top of the mixing cone 20 can advantageously prevent the cleaning and sanitizing solution from being ejected or forced from the top of the mixing cone 20 by the vigorous mixing action of the auger 12.

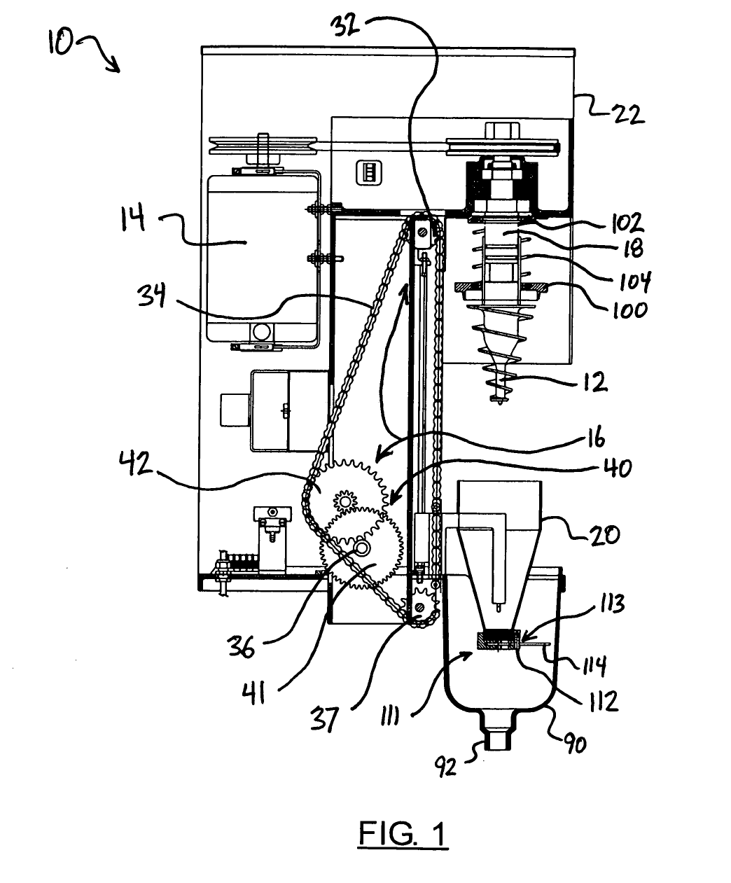

The sealing mechanism can comprise a sealing plate 100 (FIG. 1) that is attached to a gear housing component 102 from which the drive shaft 18 of the auger 12 extends. The sealing plate 100 can be substantially circular in shape and can have a central opening through which the drive shaft of the auger 12 is received for rotational movement of the drive shaft 18. The central opening in the sealing plate 100 forms a bearing surface through which the drive shaft 18 is allowed to rotate when driving the auger 12 and the sealing plate 100 can simultaneously slide longitudinally along the drive shaft 18. The sealing plate is mounted to the gear housing component 102 through a coil spring 104 that is positioned coaxially about the drive shaft 18. In its most simple implementation, the upper end of the spring 104 is attached as by welding to the housing component 102 and the lower end of the spring 104 is attached as by welding to the sealing plate 100.

The ingredients that are to be mixed into the milk shake or other similar type comestible are placed within the mixing cone 20 and the hand lever 38 is activated so as to raise the mixing cone 20 upwardly. The mixing cone moves upwardly to fully encompass and contain the mixing auger 12, and the otherwise open upper end of the mixing cone 20, which forms a substantially circular seal ring, can then make contact with the lower sealing surface of the sealing plate 100. The sealing plate 100 is forced upwardly against the spring 104 to compress the spring 104 and hold the sealing plate in tight sealing engagement with the upper end of the mixing cone 20. Once engagement of the upper end of the mixing cone 20 and the sealing plate 100 has been achieved, the auger can be operated in a high speed mode to vigorously mix and blend the materials in the mixing cone 20.

A shut off valve 111 can be provided at the lower end of the mixing cone 20 so that liquid and semi-liquid material cannot exit the mixing cone 20 when the valve 111 is closed. The shut off valve 111 can comprise a valve body 112 which has a cylindrical opening extending through the valve body 112 from top to bottom. The top end of the cylindrical opening can be conveniently provided with internal threads, and the valve body 112 can be readily attached to the lower end of the mixing cone 20 by screwing the valve body 112 to external threads that are provided on the lower end of the mixing cone 20. A horizontal slot 113 can be provided in part of the valve body 112. The slot 113 can be located between the upper and lower ends of the valve body 112. A flat sliding valve plate 114 can be adapted to slide into and out of the slot 113.

The valve plate 114 can include an elongate extension (or handle) that extends from the slot 113, and the valve plate 114 can be conveniently attached to the valve body for pivotal movement of the valve plate 114 and the extension about a vertical axis near the point where the extension projects from the slot 113. By sliding the extension to one side, the valve plate 114 can be pivoted out of the slot 113 so as to open the cylindrical opening in the valve body 112. Conversely, when the extension is moved back to its initial position extending substantially straight out of the valve body 112, the valve plate is pivoted into the slot 113 so as to close the cylindrical opening in the valve body 112.

When the mixing cone 20 and auger 12 are to be cleaned and sanitized, a cleaning and sanitizing solution can be introduced into the mixing cone 20. The hand lever 38 can be activated (generally, downwardly) so as to raise the mixing cone 20 upwardly. The mixing cone 20 moves upwardly to fully encompass and contain the mixing auger 12, and the otherwise open upper end of the mixing cone 20 makes contact with the sealing plate 100. The sealing plate 100 is generally forced upwardly against the spring 104 to compress the spring 104 and hold the sealing plate in tight sealing engagement with the upper end of the mixing cone 20. Once engagement of the upper end of the mixing cone 20 and the sealing plate 100 has been achieved, the auger can be operated in a high speed mode to vigorously wash and sanitize the auger 12 and mixing cone 20.

A catch basin or sink 90 can be advantageously provided immediately below the mixing cone 20. The sink 90 can catch any material dripping from the mixing cone 20 during normal use in making frozen desserts. In addition, the sink can collect the cleaning and sanitizing solution as it drains from the mixing cone 20 during the cleaning and sanitizing step. The sink 90 can be advantageously connected through a conventional trap 92 to a drain waste vent system. If a drain waste vent system is not available, the sink 90 can be connected to a collection vessel or tank (not shown) which would then be periodically emptied when necessary.

The present invention also advantageously provides a mechanism and means for locking and firmly holding the mixing cone 20 in a fixed, locked position, relative to the auger. This can be done in virtually any location along the direction of travel of the mixing cone relative to the auger, and is particularly useful when the mixing cone has been raised into sealing engagement with the sealing plate 100, both during mixing of comestibles in the mixing cone 20 or when cleaning and sanitizing the mixing cone 20 and auger 12 with a cleaning and sanitizing solution.

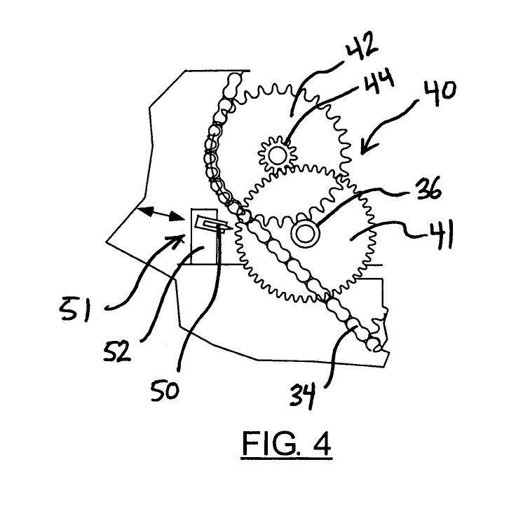

In accordance with the present invention, a novel means and mechanism for locking and securely retaining the drive system in any desired position in the travel of the mixing cone 20 can be provided. One embodiment of such means and mechanism for locking the drive system is shown schematically at 51 in FIG. 4. The drive shaft 36 of the gear mechanism 40 can be connected to and extend from a drive gear 41. The drive gear 41 in turn drives a smaller pinion gear 44 which can be attached to and turn a sprocket 42. The sprocket 42 in turn can drive the drive chain 34 as disclosed previously.

A solenoid 52 can be mounted near one of the gears. As shown in the drawings the solenoid 52 can be mounted near the smaller pinion gear 44. The solenoid can include a plunger 50 that can be normally retracted within the solenoid 52 when the solenoid 52 is not energized. When the solenoid 52 is activated or energized by having an electrical current pass through the coil of the solenoid 52, the plunger 50 is driven outwardly from its normal retracted position, and a distal end of the plunger 50 can be pushed into contact with any one of the gears of the gear mechanism 40. As shown in the drawings the distal end of the plunger can be pushed into contact with the smaller pinion gear 44, but as mentioned above can be made to engage any of the gears of the gear mechanism 40. In one aspect, the distal end of the plunger 50 can be shaped in the form of a blunt chisel such that the end can engage snugly between adjacent teeth of a gear of the gear mechanism 40, such as the drive gear 41.

When the solenoid 52 is energized, and the end of the plunger 50 engages a gear such as the smaller pinion gear 44, the gear mechanism 40 is effectively locked and can no longer move. This in turn prevents the drive chain 34 and the mixing cone 20 from further movement. The mixing cone 20 will be securely retained in its locked position until the solenoid 52 is de-energized, i.e., until electrical current is terminated through the coil of the solenoid 52. Once the solenoid 52 is de-energized, the gear mechanism 40 is freed, and the mixing cone 20 can again be moved as desired.

While the locking system is illustrated in the figures as engaging one of the lower set of gears 41, 42, 44, etc., it is to be understood that the locking system can be configured in a variety of manners. For example, the locking system may include a manually inserted pin that can engage the chain drive in a variety of positions. The locking system can also engage one of the idler gears 32, 37, if so desired.

A lock push button switch 54 (FIG. 2) can be provided to control the supply of electrical current to the solenoid 52. Operation of such a push button switch 54 will be readily understood by one of ordinary skill in the art. When pushed it reciprocates between on and off, with the switch being locked in each of the reciprocating states until again being activated to change to the alternate state. Thus, by pushing the push button switch 54, electrical current can be provided to the solenoid 52, and the electrical current will continue to be supplied to the solenoid 52 until the push button switch 54 is pushed a second time to terminate electrical current from the solenoid 52.

The push button switch 54 can be advantageously mounted on the handle 38 of the mixing machine such that it can readily be operated by the hand of the operator that is engaging the handle 38, even while the operator is manipulating the handle. The operator would then position the mixing cone in its desired position and then push the push button switch 54 to lock the mixing cone 20 in that position. The operator's hand is then free and can be used for other purposes other than continuously holding the handle 38. When it is desired to again move the mixing cone 20, the press button switch 54 is pushed again to free the drive mechanism 40 and allow further movement of the mixing cone 20. Of course, in addition to the specific location of the push button switch 54 of FIG. 2, the switch can be positioned in a variety of locations, either on or adjacent to the handle.

In addition to the structural features discussed above, the present invention also provides a method of mixing and dispensing a dessert, including: introducing ingredients into a mixing cone; positioning a motor driven auger within the mixing cone and mixing the ingredients with the auger; restricting movement of the mixing cone and the auger relative to one another; and dispensing dessert from the mixing cone while movement of the mixing cone and the auger relative to one another is restricted.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. A dessert mixing machine, comprising:
a housing;
a motor driven drive shaft associated with the housing;
an auger operably attached to the drive shaft, the auger being rotated when the motor driven shaft is rotated;
a mixing cone, the mixing cone and the auger being moveable relative to one another;
a drive assembly for moving the mixing cone and the auger relative to one another; and
a locking system, operable to restrict or limit movement of the mixing cone and the auger relative to one while the auger is being rotated by the motor driven shaft.

2. The machine of claim 1, wherein the mixing cone is coupled to a moveable carriage.

3. The machine of claim 2, further comprising a drive gear, operably coupled to the moveable carriage and operably coupled to a hand lever; wherein activation of the hand lever causes motion of the moveable carriage.

4. The machine of claim 3, wherein the locking system is operably coupled to the drive gear, and wherein activation of the locking system restricts or limits movement of the drive gear.

5. The machine of claim 1, wherein the locking system includes an actuatable pin, the actuatable pin operable to engage structure of the drive assembly to restrict movement of the mixing cone and the auger relative to one another.

6. The machine of claim 5, wherein the actuatable pin is operably coupled to a solenoid.

7. The machine of claim 1, wherein the drive assembly includes a hand lever, operable by a user of the machine to move the mixing cone and the auger relative to one another, and further comprising a locking system actuating switch coupled to the hand lever, the actuating switch being accessible to the user while grasping the hand lever.

8. The machine of claim 7, wherein the actuating switch is operably coupled to a solenoid.

9. The machine of claim 1, wherein the locking system is capable of restricting or limiting movement of the mixing cone and the auger relative to one another while the machine is mixing dessert ingredients.

10. A dessert mixing machine, comprising:
a housing;
a motor driven drive shaft associated with the housing;
an auger attached to a distal end of the drive shaft, the auger being rotatable when the motor driven shaft is rotated;
a mixing cone, the mixing cone and the auger being moveable relative to one another;
a drive assembly for causing movement of the mixing cone and the auger relative to one another, the drive assembly including a hand lever graspable by a user of the machine to move the mixing cone and the auger relative to one another;
a locking system, operable to restrict or limit movement of the mixing cone and the auger relative to one while the auger is being rotated by the motor driven shaft; and
a locking system actuating switch, selectively operable to engage and disengage the locking system, the locking system actuating switch being coupled to the hand lever to enable a user to access the actuating switch while grasping the hand lever.

11. The machine of claim 10, wherein the mixing cone is coupled to a moveable carriage.

12. The machine of claim 11, further comprising a drive gear, operably coupled to the moveable carriage and operably coupled to the hand lever; wherein activation of the hand lever causes motion of the moveable carriage.

13. The machine of claim 12, wherein the locking system is operably coupled to the drive gear, and wherein activation of the locking system restricts or limits movement of the drive gear.

14. The machine of claim 10, wherein the locking system includes an actuatable pin, the actuatable pin operable to engage structure of the drive assembly to restrict movement of the mixing cone and the auger relative to one another.

15. The machine of claim 14, wherein the actuating pin is operably coupled to a solenoid.

16. The machine of claim 10, wherein the locking system is capable of restricting or limiting movement of the mixing cone and the auger relative to one another while the machine is mixing dessert ingredients.

17. A method of mixing and dispensing a dessert, comprising:
introducing ingredients into a mixing cone;
positioning a motor driven auger within the mixing cone and mixing the ingredients with the auger;
restricting movement of the mixing cone and the auger relative to one another; and
dispensing dessert from the mixing cone while movement of the mixing cone and the auger relative to one another is restricted.

18. The method of claim 17, wherein the auger can rotate while movement of the mixing cone and the auger relative to one is restricted during dispensing of the dessert from the mixing cone.

19. The method of claim 17, wherein positioning the motor driven auger within the mixing cone is accomplished by moving a hand lever, and wherein restricting movement of the auger and the mixing cone relative to one another is accomplished by the user while grasping the hand lever.
